(19) United States
(12) Patent Application Publication
(10) Pub. No.: US 2023/0377593 A1
(43) Pub. Date: Nov. 23, 2023

(54) SPEECH PROCESSING DEVICE AND OPERATION METHOD THEREOF

(71) Applicant: AMOSENSE CO., LTD., Cheonan-si, Chungcheongnam-do (KR)

(72) Inventor: Jungmin KIM, Cheonan-si (KR)

(73) Assignee: AMOSENSE CO., LTD., Cheonan-si, Chungcheongnam-do (KR)

(21) Appl. No.: 18/029,060

(22) PCT Filed: Sep. 24, 2021
(86) PCT No.: PCT/KR2021/013072

§ 371 Date: Mar. 28, 2023

(30) Foreign Application Priority Data
Sep. 28, 2020 (KR) 10-2020-0125382

(51) Int. Cl. G10L 21/0272; G10L 15/00; G10L 25/87

(52) U.S. Cl. CPC G10L 21/0272; G10L 15/005; G10L 25/87

(57) ABSTRACT

Disclosed is a speech processing device. The speech processing device comprises: a speech reception circuit configured to receive a speech signal associated with speech uttered by speakers; a speech processing circuit configured to perform sound source separation for the speech signal on the basis of a sound source position of the speech so as to generate a separated speech signal associated with the speech and generate a translation result for the speech by using the separated speech signal; a memory; and an output circuit configured to output the translation result for the speech, wherein the sequence in which transmission results are output is determined on the basis of an utterance time point of the speech.

### TECHNICAL FIELD

Embodiments of the present disclosure relate to a voice processing device and an operating method thereof.

### BACKGROUND ART

A microphone is a device which recognizes voice, and converts the recognized voice into a voice signal that is an electrical signal. In case that a microphone is disposed in a space in which a plurality of speakers are located, such as a meeting room or a classroom, the microphone receives all voices from the plurality of speakers, and generates voice signals related to the voices from the plurality of speakers.

In case that the plurality of speakers pronounce at the same time, it is required to separate the voice signals representing only the voices of the individual speakers. Further, in case that the plurality of speakers pronounce in different languages, in order to easily translate the voices of the plurality of speakers, it is required to grasp the original languages (i.e., source languages) of the voices of the plurality of speakers, and there are problems in that it requires a lot of time and resources to grasp the languages of the corresponding voices only with the features of the voices themselves.

### SUMMARY OF INVENTION

### Technical Problem

An object of the present disclosure is to provide a voice processing device, which can generate separated voice signals related to respective voices of speakers from the voices of the speakers.

Another object of the present disclosure is to provide a voice processing device, which can sequentially provide translations for voices of speakers in a pronouncing order of the voices by using separated voice signals related to the respective voices of the speakers.

### Solution to Problem

A voice processing device according to embodiments of the present disclosure includes: a voice receiving circuit configured to receive voice signals related to voices pronounced by speakers; a voice processing circuit configured to: generate separated voice signals related to voices by performing voice source separation of the voice signals based on voice source positions of the voices, and generate translation results for the voices by using the separated voice signals; a memory; and an output circuit configured to output the translation results for the voices, wherein an output order of the translation results is determined based on pronouncing time points of the voices.

An operating method of a voice processing device according to embodiments of the present disclosure includes: receiving voice signals related to voices pronounced by speakers; generating separated voice signals related to voices by performing voice source separation of the voice signals based on voice source positions of the voices; generating translation results for the voices by using the separated voice signals; and outputting the translation results for the voices, wherein the outputting of the translation results includes: determining an output order of the translation results based on pronouncing time points of the voices; and outputting the translation results in accordance with the determined output order.

### Advantageous Effects of Invention

The voice processing device according to embodiments of the present disclosure has the effect of being able to generate the voice signals having the minimized effect of surrounding noise since the voice processing device can generate the separated voice signals related to the voices from the specific voice source positions based on the voice source positions of the voices.

The voice processing device according to embodiments of the present disclosure has the effect of being able to generate the separated voice signals related to the voices of the respective speakers from the voice signals related to the voices of the speakers.

The voice processing device according to embodiments of the present disclosure can generate the translation results for the voices of the speakers, and output the translation results in accordance with the output order determined based on the pronouncing time points of the voices of the speakers. Accordingly, the voice processing device has the effect of being able to accurately recognize and translate the voices of the speakers even if the speakers overlappingly pronounce the voices, and to smoothly perform communications between the speakers by sequentially outputting the translations of the speakers.

### BRIEF DESCRIPTION OF DRAWINGS

FIG. 1 is a diagram illustrating a voice processing device according to embodiments of the present disclosure.

FIG. 2 illustrates a voice processing device according to embodiments of the present disclosure.

FIGS. 3 to 5 are diagrams explaining an operation of a voice processing device according to embodiments of the present disclosure.

FIG. 6 is a diagram explaining a translation function of a voice processing device according to embodiments of the present disclosure.

FIG. 7 is a diagram explaining an output operation of a voice processing device according to embodiments of the present disclosure.

FIGS. 8 and 9 illustrate a voice processing device according to embodiments of the present disclosure and a vehicle.

FIG. 10 is a flowchart explaining an operation of a voice processing device according to embodiments of the present disclosure.

### DESCRIPTION OF EMBODIMENTS

Hereinafter, embodiments of the present disclosure will be described with reference to the accompanying drawings.

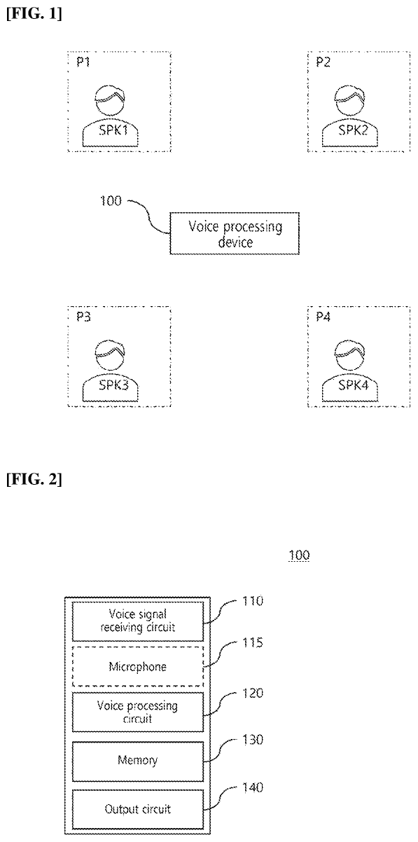

FIG. 1 is a diagram illustrating a voice processing device according to embodiments of the present disclosure. Referring to FIG. 1, a voice processing device 100 may perform voice processing of voices of speakers SPK1 to SPK4 by receiving voice signals related to the voices of the speakers SPK1 to SPK4 that are positioned in a space (e.g., meeting room, vehicle, or lecture room) and processing the voice signals.

The speakers SPK1 to SPK4 may pronounce specific voices at their own positions. According to embodiments, the first speaker SPK1 may be positioned at a first position P1, the second speaker SPK2 may be positioned at a second position P2, the third speaker SPK3 may be positioned at a third position P3, and the fourth speaker SPK4 may be positioned at a fourth position P4.

The voice processing device 100 may receive the voice signals related to the voices pronounced by the speakers SPK1 to SPK4. The voice signals are signals related to the voices pronounced for a specific time, and may be signals representing the voices of the plurality of speakers SPK1 to SPK4.

The voice processing device 100 may extract (or generate) separated voice signals related to the voices of the speakers SPK1 to SPK4 by performing voice source separation. According to embodiments, the voice processing device 100 may determine the voice source positions of the voices by using a time delay (or phase delay) between the voice signals related to the voices of the speakers SPK1 to SPK4, and generate the separated voice signal corresponding to only the voice source at the specific position. For example, the voice processing device 100 may generate the separated voice signal related to the voice pronounced at the specific position (or direction). Accordingly, the voice processing device 100 may generate the separated voice signals related to the voices of the speakers SPK1 to SPK4.

For example, the first separated voice signal may be related to the voice of the first speaker. In this case, for example, the first separated voice signal may have the highest correlation with the voice of the first speaker among the voices of the speakers. In other words, the voice component of the first speaker may have the highest proportion among voice components included in the first separated voice signal.

The voice processing device 100 may provide translations for the voices of the speakers SPK1 to SPK4. For example, the voice processing device 100 may determine source languages (translation target languages) for translating the voices of the respective speakers SPK1 to SPK4 and target languages (languages after translation), and provide the translations for the languages of the respective speakers by using the separated voice signals.

According to embodiments, the voice processing device 100 may output translation results for the voices. The translation results may be text data or voice signals related to the voices of the speakers SPK1 to SPK4 expressed in the target languages.

That is, since the voice processing device 100 according to embodiments of the present disclosure determines the source languages and the target languages in accordance with the voice source positions of the voices of the speakers SPK1 to SPK4, it has the effect of being able to provide the translations for the voices of the speakers with less time and few resources without the necessity of identifying in what languages the voices of the speakers are.

For example, the voice processing device 100 may generate the separated voice signal corresponding to the voice of a specific speaker based on the voice source positions of the received voices. For example, if the first speaker SPK1 and the second speaker SPK2 pronounce the voices together, the voice processing device 100 may generate the first separated voice signal related to the voice of the first speaker SPK1 and the second separated voice signal related to the voice of the second speaker SPK2.

FIG. 2 illustrates a voice processing device according to embodiments of the present disclosure. Referring to FIGS. 1 and 2, the voice processing device 100 may include a voice signal receiving circuit 110, a voice processing circuit 120, a memory 130, and an output circuit 140.

The voice signal receiving circuit 110 may receive the voice signals corresponding to the voices of the speakers SPK1 to SPK4. According to embodiments, the voice signal receiving circuit 110 may receive the voice signals in accordance with the wired communication method or the wireless communication method. For example, the voice signal receiving circuit 110 may receive the voice signals from a voice signal generating device, such as microphones, but is not limited thereto.

According to embodiments, the voice signals received by the voice signal receiving circuit 110 may be signals related to the voices of the plurality of speakers. For example, in case that the first speaker SPK1 and the second speaker SPK2 pronounce the voices as overlapping each other in time, the voices of the first speaker SPK1 and the second speaker SPK2 may overlap each other.

The voice processing device 100 may further include a microphone 115, but in accordance with embodiments, the microphone 115 may be implemented separately from the voice processing device 100 (e.g., as another device), and the voice processing device 100 may receive the voice signal from the microphone 115.

Hereinafter, in the description, explanation will be made under the assumption that the voice processing device 100 includes the microphone 115, but embodiments of the present disclosure may be applied in the same manner even in case of not including the microphone 115.

The microphone 115 may receive the voices of the speakers SPK1 to SPK4, and generate the voice signals related to the voices of the speakers SPK1 to SPK4.

According to embodiments, the voice processing device 100 may include a plurality of microphones 115 arranged in the form of an array, the plurality of microphones 115 may measure a pressure change of a medium (e.g., air) caused by the voices, convert the measured pressure change of the medium into voice signals that are electrical signals, and output the voice signals. Hereinafter, in the description, explanation will be made under the assumption that the plurality of microphones 115 are provided.

The voice signals generated by the microphones 115 may correspond to the voices of at least one speaker SPK1 to SPK4. For example, in case that the speakers SPK1 to SPK4 pronounce the voices at the same time, the voice signals generated by the respective microphones 115 may be signals representing the voices of all the speakers SPK1 to SPK4.

The microphones 115 may multi-directionally receive the voices. According to embodiments, the microphones 115 may be disposed to be spaced apart from each other to constitute one microphone array, but embodiments of the present disclosure are not limited thereto.

The voice processing circuit 120 may process the voice signals. According to embodiments, the voice processing circuit 120 may include a processor having an arithmetic processing function. For example, the processor 120 may be a digital signal processor (DSP), a central processing unit (CPU), or a micro processing unit (MCU), but is not limited thereto.

For example, the voice processing circuit 120 may perform analog-to-digital conversion of the voice signals received by the voice signal receiving circuit 110, and process the digital-converted voice signals.

The voice processing circuit 120 may extract (or generate) the separated voice signals related to the voices of the speakers SPK1 to SPK4 by using the voice signals.

The voice processing circuit 120 may determine the voice source positions (i.e., positions of the speakers SPK1 to SPK4) of the voice signals by using the time delay (or phase delay) between the voice signals. For example, the voice processing circuit 120 may generate voice source position information representing the voice source positions (i.e., positions of the speakers SPK1 to SPK4) of the voice signals.

The voice processing circuit 120 may generate the separated voice signals related to the voices of the speakers SPK1 to SPK4 from the voice signals based on the determined voice source positions. For example, the voice processing circuit 120 may generate the separated voice signals related to the voices pronounced at specific positions (or directions).

In this case, the voice processing circuit 120 may grasp the voice source positions of the voices of the first speaker SPK1 and the second speaker SPK2 by using the voice signals, and generate a first separated voice signal related to the voice of the first speaker SPK1 and a second separated voice signal representing the voice of the second speaker SPK2 based on the voice source positions.

According to embodiments, the voice processing circuit 120 may match and store the separated voice signals with the voice source position information. For example, the voice processing circuit 120 may match and store the first separated voice signal related to the voice of the first speaker SPK1 with first voice source position information representing the voice source position of the voice of the first speaker SPK1.

The voice processing circuit 120 may perform translation for the voices of the speakers SPK1 to SPK4 by using the separated voice signals, and generate the translation results. For example, the voice processing device 100 may determine the source languages (translation target languages) for translating the voices of the respective speakers SPK1 to SPK4 and the target languages (languages after translation), and provide the translations for the languages of the respective speakers.

The translation results may be text data or voice signals related to the voices of the speakers SPK1 to SPK4 expressed in the target languages.

The memory 130 may store data required to operate the voice processing device 100. According to embodiments, the memory 130 may store the separated voice signals and the voice source position information.

The output circuit 140 may output data. According to embodiments, the output circuit 140 may include a communication circuit configured to transmit the data to an external device, a display device configured to output the data in a visual form, or a loudspeaker device configured to output the data in an auditory form, but embodiments of the present disclosure are not limited thereto.

According to embodiments, if the output circuit 140 includes the communication circuit, the output circuit 140 may transmit the data to the external device, or receive the data from the external device. For example, the output circuit 140 may support the communication methods, such as WiFi, Bluetooth, Zigbee, NFC, Wibro, WCDMA, 3G, LTE, and 5G. For example, the output circuit 140 may transmit the translation results to the external device in accordance with the control of the voice processing circuit 120.

According to embodiments, if the output circuit 140 includes the display device, the output circuit 140 may output the data in the visual form (e.g., image or image form). For example, the output circuit 140 may display an image representing texts corresponding to the translation results.

According to embodiments, if the output circuit 140 includes the loudspeaker device, the output circuit 140 may output the data in the auditory form (e.g., voice form). For example, the output circuit 140 may reproduce the voices corresponding to the translation results.

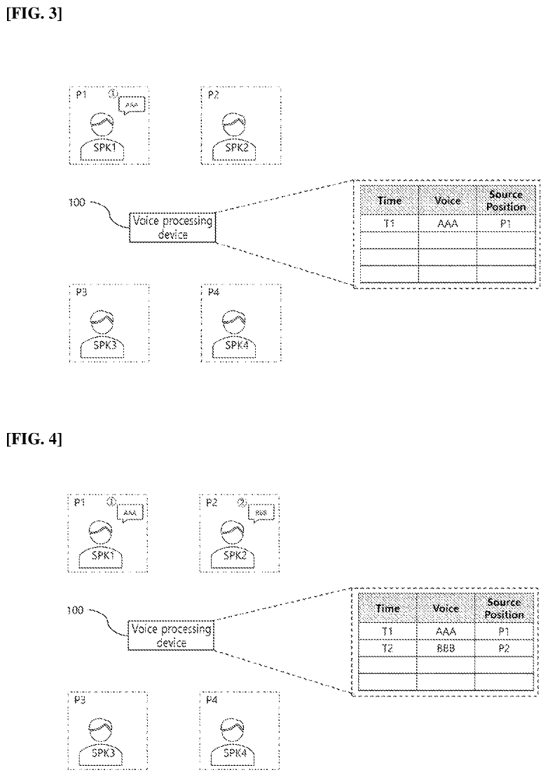

FIGS. 3 to 5 are diagrams explaining an operation of a voice processing device according to embodiments of the present disclosure. Referring to FIGS. 1 to 5, speakers SPK1 to SPK4 positioned at positions P1 to P4 may pronounce voices. The voice processing device 100 may receive the voices of the speakers SPK1 to SPK4, and generate the separated voice signals related to the voices of the speakers SPK1 to SPK4.

Further, according to embodiments, the voice processing device 100 may store the voice source position information representing the voice source positions of the voices of the respective speakers SPK1 to SPK4.

Further, according to embodiments, the voice processing device 100 may judge pronouncing time points of the voices of the respective speakers SPK1 to SPK4 by using the separated voice signals, and generate and store pronouncing time point information representing the pronouncing time points.

As illustrated in FIG. 3, the first speaker SPK1 may pronounce voice “AAA” at a first time point T1. The voice processing device 100 may receive the voice signal, and generate the first separated voice signal related to the voice “AAA” from the voice signal based on the voice source position of the voice “AAA”.

For example, the voice processing device 100 may generate and store the first voice source position information representing the voice source position P1 of the voice “AAA” of the first speaker SPK1. For example, the voice processing device 100 may generate and store the first pronouncing time point information representing the first time point T1 that is the pronouncing time point of the voice “AAA”.

As illustrated in FIG. 4, the second speaker SPK2 may pronounce voice “BBB” at a second time point T2 after the first time point T1. The voice processing device 100 may receive the voice signal, and generate the second separated voice signal related to the voice “BBB” from the voice signal based on the voice source position of the voice “BBB”.

In this case, although the pronouncing section of the voice “AAA” and the pronouncing section of the voice “BBB” may overlap each other at least partly, the voice processing device 100 according to embodiments of the present disclosure may generate the first separated voice signal related to the voice “AAA” and the second separated voice signal related to the voice “BBB”.

For example, the voice processing device 100 may generate and store the second voice source position information representing the voice source position P2 of the voice “BBB” of the second speaker SPK2. For example, the voice processing device 100 may generate and store the second pronouncing time point information representing the second time point T2 that is the pronouncing time point of the voice “BBB”.

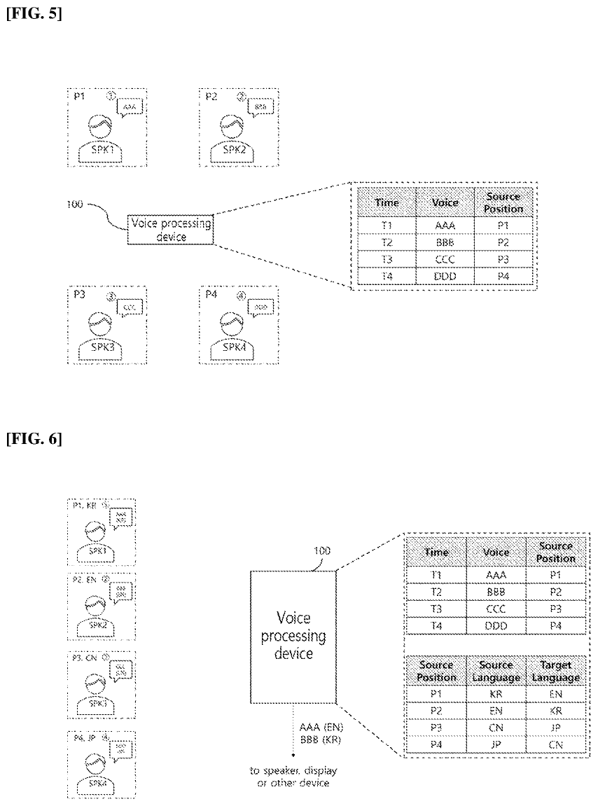

As illustrated in FIG. 5, the third speaker SPK3 may pronounce voice “CCC” at a third time point T3 after the second time point T2, and the fourth speaker SPK4 may pronounce voice “DDD” at a fourth time point T4 after the third time point T3. The voice processing device 100 may receive the voice signal, and generate the third separated voice signal related to the voice “CCC” from the voice signal based on the voice source position of the voice “CCC”, and generate the fourth separated voice signal related to the voice “DDD” from the voice signal based on the voice source position of the voice “DDD”.

For example, the voice processing device 100 may generate and store the third voice source position information representing the voice source position P3 of the voice “CCC” of the third speaker SPK3 and the fourth voice source position information representing the voice source position P4 of the voice “DDD” of the fourth speaker SPK4.

For example, the voice processing device 100 may generate and store the third pronouncing time point information representing the third time point T3 that is the pronouncing time point of the voice “CCC” and the fourth pronouncing time point information representing the fourth time point T4 that is the pronouncing time point of the voice “DDD”.

FIG. 6 is a diagram explaining a translation function of a voice processing device according to embodiments of the present disclosure. Referring to FIGS. 1 to 6, the voice processing device 100 may generate the separated voice signals related to the voices of the speakers SPK1 to SPK4, and output the translation results for the voices of the speakers SPK1 to SPK4 by using the separated voice signals.

As illustrated in FIG. 6, the first speaker SPK1 pronounces the voice “AAA” in Korean (KR), the second speaker SPK2 pronounces the voice “BBB” in English (EN), the third speaker SPK3 pronounces the voice “CCC” in Chinese (CN), and the fourth speaker SPK4 pronounces the voice “DDD” in Japanese (JP). In this case, the source language of the voice “AAA” of the first speaker SPK1 is Korean (KR), the source language of the voice “BBB” of the second speaker SPK2 is English (EN), the source language of the voice “CCC” of the third speaker SPK3 is Chinese (CN), and the source language of the voice “DDD” of the fourth speaker SPK4 is Japanese (JP).

In this case, the voices “AAA”, “BBB”, “CCC”, and “DDD” are sequentially pronounced.

As described above, the voice processing device 100 may determine the voice source positions of the voices of the speakers SPK1 to SPK4 by using the voice signals corresponding to the voices of the speakers SPK1 to SPK4, and generate the separated voice signals related to the voices of the respective speakers based on the voice source positions. For example, the voice processing device 100 may generate the first separated voice signal related to the voice “AAA (KR)” of the first speaker SPK1.

According to embodiments, the voice processing device 100 may generate and store the voice source position information representing the voice source positions of the voices of the speakers SPK1 to SPK4.

According to embodiments, the voice processing device 100 may generate and store pronouncing time point information representing pronouncing time points of the voices.

The voice processing device 100 according to embodiments of the present disclosure may provide translations for the voices of the speakers SPK1 to SPK4 by using the separated voice signals related to the voices of the speakers SPK1 to SPK4. For example, the voice processing device 100 may provide the translation for the voice “AAA (KR)” pronounced by the first speaker SPK1.

The voice processing device 100 may provide the translations from the source languages to the target languages for the languages of the voices of the speakers SPK1 to SPK4 based on the source languages and the target languages determined in accordance with the voice source positions.

According to embodiments, the voice processing device 100 may store source language information representing the source languages and target language information representing the target languages. The source languages and the target languages may be determined in accordance with the voice source positions. For example, the source language information and the target language information may be matched and stored with the voice source position information.

For example, as illustrated in FIG. 6, the voice processing device 100 may generate and store the first source language information indicating that the source language for the first position P1 (i.e., first speaker SPK1) is Korean (KR) and the first target language information indicating that the target language is English (EN). In this case, the first source language information and the first target language information may be matched and stored with the first voice source position information representing the first position P1.

The voice processing device 100 may output the translation results for the voices of the speakers SPK1 to SPK4 by using the source language information and the target language information corresponding to the voice source positions.

The voice processing device 100 may determine the source languages for translating the voices of the speakers SPK1 to SPK4 and the target languages based on the voice source position information corresponding to the voice source positions of the separated voice signals. According to embodiments, the voice processing device 100 may determine the source languages for translating the voices of the speakers SPK1 to SPK4 and the target languages by reading the source language information corresponding to the voice source positions and the target language information by using the voice source position information for the voices of the speakers SPK1 to SPK4.

For example, the voice processing device 100 may read the first source language information corresponding to the first position P1 and the first target language information from the memory 130 by using the first voice source position information representing the first position P1 that is the voice source position of the voice “AAA (KR)” of the first speaker SPK1. The read first source language information indicates that the source language of the voice “AAA” of the first speaker SPK1 is Korean (KR), and the first target language information indicates that the target language of the voice “AAA” of the first speaker SPK1 is English (EN).

The voice processing device 100 may provide the translations for the voices of the speakers SPK1 to SPK4 based on the determined source languages and target languages. According to embodiments, the voice processing device 100 may generate the translation results for the voices of the speakers SPK1 to SPK4.

In the description, the translation result that is output by the voice processing device 100 may be text data expressed in the target language or the voice signal related to the voice pronounced in the target language, but is not limited thereto.

In the description, the generation of the translation results by the voice processing device 100 includes not only generation of the translation results by translating the languages through an arithmetic operation of the voice processing circuit 120 of the voice processing device 100 but also generation of the translation results by receiving the translation results from a server having a translation function through communication with the server.

For example, the voice processing circuit 120 may generate the translation results for the voices of the speakers SPK1 to SPK4 by executing the translation application stored in the memory 130.

For example, the voice processing device 100 may transmit the separated voice signals, source language information, and target language information to translators, and receive the translation results for the separated voice signals from the translators. The translators may mean an environment or a system that provides the translations for the languages. According to embodiments, the translators may output the translation results for the voices of the speakers SPK1 to SPK4 by using the separated voice signals, the source language information, and the target language information.

For example, the voice processing device 100 may generate the translation result “AAA (EN)” for the voice of the first speaker SPK1 that is expressed in English (EN) by using the separated voice signal related to the voice “AAA (KR)” of the first speaker SPK1 that is expressed in Korean (KR). Further, for example, the voice processing device 100 may generate the translation result “BBB (KR)” for the voice of the second speaker SPK2 that is expressed in Korean (KR) by using the separated voice signal related to the voice “BBB (EN)” of the second speaker SPK2 that is expressed in English (EN).

In the same manner, the voice processing device 100 may generate the translation results for the voice “CCC (CN)” of the third speaker SPK3 and the voice “DDD (JP)” of the fourth speaker SPK4.

The voice processing device 100 may output the translation results for the voices of the speakers SPK1 to SPK4. According to embodiments, the voice processing device 100 may visually or audibly output the translation results through an output device, such as a display or a loudspeaker. For example, the voice processing device 100 may output the voice “AAA (EN)” that is the translation result for the voice “AAA (KR)” of the first speaker SPK1 through an output device.

To be described later, the voice processing device 100 may determine the output order of the translation results for the voices of the speakers SPK1 to SPK4, and output the translation results in accordance with the determined output order.

The voice processing device 100 according to embodiments of the present disclosure may generate the separated voice signals related to the voices of the speakers SPK1 to SPK4, determine the source languages and the target language in accordance with the voice source positions of the voices of the speakers SPK1 to SPK4 by using the separated voice signals, and translate the voices of the speakers SPK1 to SPK4. Further, the voice processing device 100 may output the translation results.

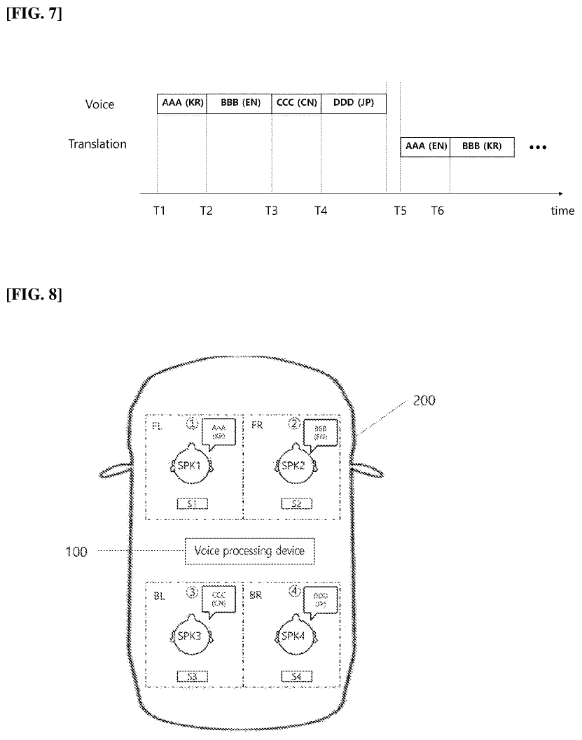

FIG. 7 is a diagram explaining an output operation of a voice processing device according to embodiments of the present disclosure. Referring to FIGS. 1 to 7, the voice processing device 100 may output the translation results for the voices of the speakers SPK1 to SPK4.

The voice processing device 100 may determine the output order of the translation results for the voices based on the pronouncing time points of the voices of the speakers SPK1 to SPK4. According to embodiments, the voice processing device 100 may generate pronouncing time point information representing pronouncing time points of the voices based on the voice signals related to the voices. The voice processing device 100 may determine the output order for the voices based on the pronouncing time point information, and output the translation results in accordance with the determined output order.

In the description, the output of the translation results in accordance with the specific output order by the voice processing device 100 may be not only the sequential output of the translation results for the voices in accordance with the specific output order by the voice processing device 100 but also the output of data for outputting the translation results in accordance with the specific order.

For example, if the translation result is the translated voice, the voice processing device 100 may sequentially output the voice signals related to the translated voices of the speakers in accordance with the specific output order, or output the voice signals in which the translated voices are reproduced in accordance with the specific output order.

For example, the voice processing device 100 may determine the output order of the translation results so as to be the same as the pronouncing order of the voices, and output the translation results for the voices in accordance with the determined output order. That is, by the voice processing device 100, the translation result for the first pronounced voice may be first output.

For example, as illustrated in FIG. 7, in case that the voice “AAA (KR)” is pronounced at the first time point T1, and the voice “BBB (EN)” is pronounced at the second time point T2 after the first time point T1, “AAA (EN)” that is the translation result for the voice “AAA (KR)” may be output at the fifth time point T5, and “BBB (KR)” that is the translation result for the voice “BBB” may be output at the sixth time point T6 after the fifth time point T5. That is, the “AAA (EN)” that is the translation result for the relatively first pronounced voice “AAA (KR)” may be relatively first output.

Meanwhile, although FIG. 7 illustrates that the translation results “AAA (EN)” and “BBB (KR)” are output after the voices “AAA (KR)”, “BBB (EN)”, “CCC (CN)”, and “DDD (JP)” are all pronounced, it is natural that the translation results may be output before the voices are all pronounced. However, the output order of the translation results may be the same as the pronouncing order of the corresponding voices.

The voice processing device 100 according to embodiments of the present disclosure may determine the source languages and the target languages in accordance with the voice source positions of the voices of the speakers SPK1 to SPK4, translate the voices of the speakers SPK1 to SPK4 in accordance with the determined source languages and target languages, and output the translation results. In this case, the translation results may be output in accordance with the output order that is determined in accordance with the pronouncing time points of the voices of the speakers SPK1 to SPK4. Accordingly, not only the voices of the speakers can be accurately recognized and translated even if the speakers SPK1 to SPK4 overlappingly pronounce the voices, but also the translations of the speakers SPK1 to SPK4 can be sequentially output, so that the communications between the speakers SPK1 to SPK4 can be smoothly performed.

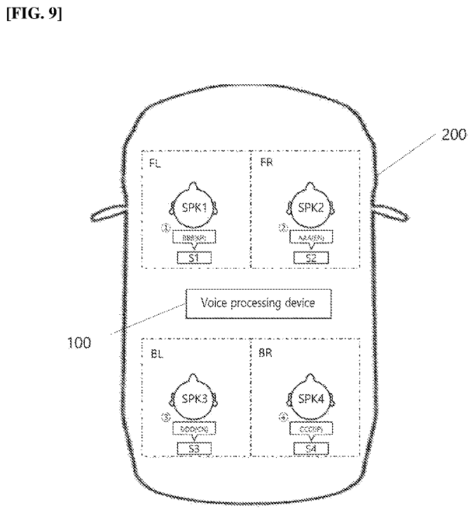

FIGS. 8 and 9 illustrate a voice processing device according to embodiments of the present disclosure and a vehicle.

Referring to FIG. 8, the first speaker SPK1 may be positioned in a front row left area FL of a vehicle 200, and may pronounce the voice “AAA” in Korean (KR). The second speaker SPK2 may be positioned in a front row right area FR of the vehicle 200, and may pronounce the voice “BBB” in English (EN). The third speaker SPK3 may be positioned in a back row left area BL of the vehicle 200, and may pronounce the voice “CCC” in Chinese (CN). The fourth speaker SPK4 may be positioned in a back row right area BR of the vehicle 200, and may pronounce the voice “DDD” in Japanese (JP).

As described above, the voice processing device 100 may provide the translations for the voices of the speakers SPK1 to SPK4 by using the separated voice signals related to the voices of the speakers SPK1 to SPK4. For example, the voice processing device 100 may provide the translation for the voice “AAA (KR)” pronounced by the first speaker SPK1.

Referring to FIG. 9, the voice processing device 100 may transmit the translation results for the voices of the speakers SPK1 to SPK4 to the vehicle 200. The translation results may be output through loudspeakers S1 to S4 installed in the vehicle 200.

The vehicle 200 may include an electronic controller unit (ECU) for controlling the vehicle 200. The electronic controller unit may control the overall operation of the vehicle 200. For example, the electronic controller unit may control the operations of the loudspeakers S1 to S4.

The loudspeakers S1 to S4 may receive the voice signals, and output the voices corresponding to the voice signals. According to embodiments, the loudspeakers S1 to S4 may generate vibrations based on the voice signals, and the voices may be reproduced in accordance with the vibrations of the loudspeakers S1 to S4.

According to embodiments, the loudspeakers S1 to S4 may be disposed at positions of the respective speakers SPK1 to SPK4. For example, the loudspeakers S1 to S4 may be loudspeakers disposed on headrests of the seats on which the respective speakers SPK1 to SPK4 are positioned, but embodiments of the present disclosure are not limited thereto.

The translation results for the voices of the speakers SPK1 to SPK4 may be output through the loudspeakers S1 to S4 in the vehicle 200. According to embodiments, the translation results for the voices of the speakers SPK1 to SPK4 may be output through specific loudspeakers among the loudspeakers S1 to S4.

For example, the vehicle 200 may reproduce the translated voices by transmitting, to the loudspeakers S1 to S4, the voice signals related to the translated voices of the speakers SPK1 to SPK4 that are transmitted from the voice processing device 100. Further, for example, the voice processing device 100 may transmit the voice signals related to the translated voices of the speakers SPK1 to SPK4 to the loudspeakers S1 to S4.

The voice processing device 100 may determine the positions of the loudspeakers S1 to S4 from which the translation results for the voices of the speakers SPK1 to SPK4 are to be output. According to embodiments, the voice processing device 100 may generate the output position information representing the positions of the loudspeakers from which the translation results are to be output.

For example, the translation results for the voices of the speakers positioned in a first row (e.g., front row) of the vehicle 300 may be output from the loudspeakers disposed in the first row (e.g., front row) that is the same row.

For example, the voice processing device 100 may generate the output position information so that the target languages at the voice source positions of the voices to be translated and the source languages corresponding to the positions of the loudspeakers from which the translation results are to be output are the same based on the source language information and the target language information for the voice source positions of the voices of the speakers SPK1 to SPK4.

However, a method for determining the positions of the loudspeakers from which the translation results are to be output is not limited to the above method.

In accordance with the output position information, the translation results for the voices of the speakers SPK1 to SPK4 may be output from the corresponding loudspeakers among the loudspeakers S1 to S4.

According to embodiments, the voice processing device 100 may transmit, to the vehicle 300, the output position information representing the positions of the loudspeakers from which the corresponding translation results are to be output together with the translation results, and the vehicle 300 may determine the loudspeakers from which the translation results for the corresponding voices are to be output among the loudspeakers S1 to S4 by using the output position information, and transmit the voice signals related to the translated voices to be output from the determined loudspeakers.

Further, according to embodiments, the voice processing device 100 may determine the loudspeakers to output the translation results for the corresponding voices among the loudspeakers S1 to S4 by using the output position information, and transmit the voice signals related to the translated voices to be output from the determined loudspeakers.

For example, in FIGS. 8 and 9, since the target language at the front row left position and the source language at the front row right position are English (EN), the translation result “AAA (EN)” for the voice at the front row left position may be output from the loudspeaker S2 positioned at the front row right.

Further, the voice processing device 100 may determine the output order of the translation results, and the translation results may be output in accordance with the determined output order. For example, the voice processing device 100 may determine the output order in which the translation results are to be output based on the pronouncing time points of the voices of the speakers SPK1 to SPK4. Further, for example, the voice processing device 100 may output the translation results for the voices to the vehicle 200 in accordance with the determined output order, or transmit, to the vehicle 200, the voice signals for outputting the translated voices in accordance with the determined output order.

For example, as illustrated in FIGS. 8 and 9, the voices may be pronounced in the order of “AAA (KR)”, “BBB (EN)”, “CCC (CN)”, and “DDD (JP)”, and thus the translation results may also be output in the order of “AAA (EN)”, “BBB (KR)”, “CCC (JP)”, and “DDD (CN)”. That is, after “AAA (EN)” is output from the first loudspeaker S1, “BBB (KR)” may be output from the second loudspeaker S2.

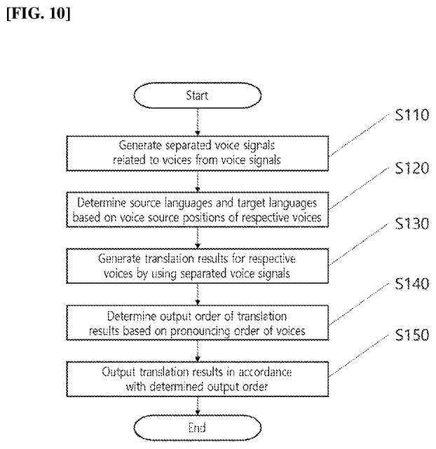

FIG. 10 is a flowchart explaining an operation of a voice processing device according to embodiments of the present disclosure. Referring to FIGS. 1 to 10, the voice processing device 100 may generate the separated voice signals related to the voices of the speakers SPK1 to SPK4 from the voice signals (S110). According to embodiments, the voice processing device 100 may receive the voice signals related to the voices of the speakers SPK1 to SPK4, and extract or separate the separated voice signals from the voice signals.

The voice processing device 100 may determine the source languages and the target languages for the voices of the speakers SPK1 to SPK4 (S120). According to embodiments, the voice processing device 100 may refer to the memory 130, and may determine the source languages and the target languages for the separated voice signals by reading the source language information and the target language information corresponding to the voice source positions of the voices related to the separated voice signals.

The voice processing device 100 may generate the translation results for the voices of the speakers SPK1 to SPK4 by using the separated voice signals (S130). According to embodiments, the voice processing device 100 may generate the translation results through a self-translation algorithm stored in the voice processing device 100, or may transmit the separated voice signals and the target language and source language information to the communicable translators, and receive the translation results from the translators.

The voice processing device 100 may determine the output order of the translation results based on the pronouncing order of the voices (S140). According to embodiments, the voice processing device 100 may judge the pronouncing order of the voices of the speakers SPK1 to SPK4, and determine the output order of the translation results for the voices based on the judged pronouncing order. For example, the pronouncing order of the voices and the output order of the translation results for the corresponding voices may be the same.

The voice processing device 100 may output the translation results in accordance with the determined output order (S150). For example, the translation results generated by the voice processing device 100 may be output through the loudspeakers, and the output order of the translated voices being output through the loudspeakers may be the same as the pronouncing order of the voices.

The voice processing system according to embodiments of the present disclosure may generate the separated voice signals related to the voices of the speakers SPK1 to SPK4, determine the source languages and the target languages in accordance with the voice source positions of the voices of the speakers SPK1 to SPK4 by using the separated voice signals, translate the voices of the speakers SPK1 to SPK4, and output the translation results. In this case, the translation results may be output in accordance with the output order that is determined in accordance with the pronouncing time points of the voices of the speakers SPK1 to SPK4.

As described above, although embodiments have been described by the limited embodiments and drawings, those of ordinary skill in the corresponding technical field can make various corrections and modifications from the above description. For example, proper results can be achieved even if the described technologies are performed in a different order from that of the described method, and/or the described constituent elements, such as the system, structure, device, and circuit, are combined or assembled in a different form from that of the described method, or replaced by or substituted with other constituent elements or equivalents.

Accordingly, other implementations, other embodiments, and equivalents to the claims belong to the scope of the claims to be described later.

### INDUSTRIAL APPLICABILITY

Embodiments of the present disclosure relate to a voice processing device and an operating method thereof.

1. A voice processing device comprising:
a voice receiving circuit configured to receive voice signals related to voices pronounced by speakers;
a voice processing circuit configured to: generate separated voice signals related to voices by performing voice source separation of the voice signals based on voice source positions of the voices, and generate translation results for the voices by using the separated voice signals;
a memory; and
an output circuit configured to output the translation results for the voices,
wherein an output order of the translation results is determined based on pronouncing time points of the voices.

2. The voice processing device of claim 1, wherein the translation results include the voice signals related to voices obtained by translating the voices or text data related to texts obtained by translating the texts corresponding to the voices.

3. The voice processing device of claim 1, comprising a plurality of microphones disposed to form an array,
wherein the plurality of microphones are configured to generate the voice signals in response to the voices.

4. The voice processing device of claim 3, wherein the voice processing circuit is configured to:
judge the voice source positions of the respective voices based on a time delay among a plurality of voice signals generated from the plurality of microphones, and
generate the separated voice signals based on the judged voice source positions.

5. The voice processing device of claim 3, wherein the voice processing circuit is configured to: generate voice source position information representing the voice source positions of the voices based on a time delay among a plurality of voice signals generated from the plurality of microphones, and match and store, in the memory, the voice source position information for the voices with the separated voice signals for the voices.

6. The voice processing device of claim 1, wherein the voice processing circuit is configured to:
determine the source languages for translating the voices related to the separated voice signals and the target languages with reference to the source language information corresponding to the voice source positions of the separated voice signals stored in the memory and the target language information, and
generate the translation results by translating languages of the voices from the source languages to the target languages.

7. The voice processing device of claim 1, wherein the voice processing circuit is configured to: judge pronouncing time points of the voices pronounced by the speakers based on the voice signals, and determine an output order of the translation results so that the output order of the translation results and a pronouncing order of the voices are the same, and
wherein the output circuit is configured to output the translation results in accordance with the determined output order.

8. The voice processing device of claim 1, wherein the voice processing circuit is configured to generate a first translation result for a first voice pronounced at a first time point and a second translation result for a second voice pronounced at a second time point after the first time point, and
wherein the first translation result is output prior to the second translation result.

9. An operating method of a voice processing device, the operating method comprising:
receiving voice signals related to voices pronounced by speakers;
generating separated voice signals related to voices by performing voice source separation of the voice signals based on voice source positions of the voices;
generating translation results for the voices by using the separated voice signals; and
outputting the translation results for the voices,
wherein the outputting of the translation results includes:
determining an output order of the translation results based on pronouncing time points of the voices; and
outputting the translation results in accordance with the determined output order.

10. The operating method of claim 9, wherein the translation results include the voice signals related to voices obtained by translating the voices or text data related to texts obtained by translating the texts corresponding to the voices.

11. The operating method of claim 9, wherein the generating of the separated voice signals comprises:
judging the voice source positions of the respective voices based on a time delay among a plurality of voice signals generated from the plurality of microphones; and
generating the separated voice signals based on the judged voice source positions.

12. The operating method of claim 9, wherein the generating of the translation results comprises:
determining the source languages for translating the voices related to the separated voice signals and the target languages with reference to the source language information corresponding to the voice source positions of the stored separated voice signals and the target language information; and
generating the translation results by translating languages of the voices from the source languages to the target languages.

13. The operating method of claim 9, wherein the determining of the output order comprises:
judging pronouncing time points of the voices pronounced by the speakers based on the voice signals; and
determining an output order of the translation results so that the output order of the translation results and a pronouncing order of the voices are the same.

14. The operating method of claim 9, wherein the generating of the translation results comprises:
generating a first translation result for a first voice pronounced at a first time point; and
generating a second translation result for a second voice pronounced at a second time point after the first time point, and
wherein the outputting of the translation results includes outputting the first translation result prior to the second translation result.
